(19) United States
(12) Patent Application Publication
(10) Pub. No.: US 2023/0297138 A1
(43) Pub. Date: Sep. 21, 2023

(54) DEVICE CASE GUARD WITH DISPLAY SCREEN

(71) Applicant: Iman Ahari Hashemi, Daytona Beach, FL (US)

(72) Inventor: Iman Ahari Hashemi, Daytona Beach, FL (US)

(21) Appl. No.: 18/186,005

(22) Filed: Mar. 17, 2023

Related U.S. Application Data
(63) Continuation-in-part of application No. 29/792,322, filed on Mar. 21, 2022.

(51) Int. Cl. G06F 1/16; A45C 11/00; H04B 1/3888

(52) U.S. Cl. CPC G06F 1/165; A45C 11/00; H04B 1/3888; G06F 1/1683; G06F 1/1656; A45C 2011/002

(57) ABSTRACT

This disclosure relates to an improved protective case for fragile and/or portable devices including smartphones, tablets, and luggage that includes one or more displays. The protective case includes memory for storing videos and images and other circuitry for receiving the multimedia from an external source and for displaying it on the one or more displays of the protective case. The displays of the protective case can be controlled through an application on an electronic device and this application can further be used to send multimedia files to the protective case or delete multimedia files from the memory of the protective case. Other embodiments are disclosed herein as well.

### CROSS-REFERENCE TO RELATED APPLICATIONS

This continuation-in-part application claims benefit of, and priority to, U.S. Design application No. 29/792,322 filed on Mar. 21, 2022. The content of the above-identified application is herein incorporated by reference in its entirety.

### TECHNICAL FIELD

This disclosure is related to improved systems, methods, and techniques for cases for portable and/or fragile devices including but not limited to cell phones, tablets, laptop computers, other portable electronic devices, and jewelry boxes. In certain embodiments, the systems, methods, and techniques described herein can be executed to display images, text, and/or videos stored on the portable electronic device on a screen embedded in the case.

### BACKGROUND

Portable electronic devices have become ubiquitous in the United States of America. It is not uncommon for a single person to have a smartphone, a tablet, a laptop, and other portable electronic devices including but not limited to mp3 (MPEG layer 3) players and cameras. While these devices are generally small and lightweight, they are also fragile. They include numerous components such as microprocessors, microcontrollers, memory chips, antennae, circuit boards, microphones, audio speakers, etc. that are susceptible to breaking or damage. These devices also include displays, such as those based on liquid crystal display (LCD) or organic light emitting diode (OLED) technology, and camera lenses, which can also be cracked or broken.

One solution to prevent damage to electronic portable devices is to use cases (which also may be referred to as guards). These cases are typically made out of plastic, rubber, or a similar material and provide additional protection to the portable electronic device. They help protect the electronics inside the device while also helping to prevent scratches and other blemishes to the exterior of the device. These cases may be monochromatic or they may incorporate a design or pattern. They can incorporate other images as well, including pictures, text, brands, logos, or images of persons or characters from fiction. However, these images or designs on the cases are static and cannot be changed by the person using the portable electronic device without removing the case and replacing it with another case with a different design. This approach to protecting a portable electronic device has proven to be unsatisfactory.

U.S. Pat. No. 9,369,170 discloses a protective case for mobile devices that includes cameras and other sensors where the camera lenses and other sensors are also protected. KR 2005-0113807 describes a method of using a portable device to present a slide show. KR 2007-0087744 provides for a mobile device with at least two LCD screens. While this provides additional screen space for the user, it does not provide any additional protection for the device itself. U.S. Pat. No. 9,215,306 and European Patent No. 2,129,103 disclose an improved portable device including a transparent display. None of these references provide additional protection for the electronic device (or for other types of fragile devices) while also providing for customizable and changeable design options.

What is needed is a case for a portable electronic device or other fragile device that can protect the device while also providing the user with the ability to update the case's design without changing cases altogether. What is also needed are systems, apparatuses, and methods for allowing a user to display images or videos stored on the portable electronic device or other device on the case.

### BRIEF DESCRIPTION OF DRAWINGS

To facilitate further description of the embodiments, the following drawings are provided, in which like references are intended to refer to like or corresponding parts, and in which:

FIG. 1A is a block diagram of the components of an exemplary system for the device protective case in accordance with certain embodiments;

FIG. 1B is a diagram demonstrating exemplary features of the device protective case in accordance with certain embodiments;

FIG. 1C is a diagram demonstrating exemplary features of the device protective case in accordance with certain embodiments;

FIG. 1D is a diagram demonstrating exemplary features of the device protective case in accordance with certain embodiments;

FIG. 2 is a block diagram showing the exemplary set of functional features of the application that communicates with and helps control the device protective case in accordance with certain embodiments; and

FIG. 3 is a flowchart illustrating an exemplary method in accordance with certain embodiments.

FIG. 4 is an illustration demonstrating exemplary features of the device protective case in accordance with certain case structures;

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein.

The terms “left,” “right,” “front,” “rear,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

### DETAILED DESCRIPTION OF EXEMPLARY EMBODIMENTS

The present disclosure relates to systems, methods, apparatuses, computer program products, and techniques for providing for a device protective case that can display different images and/or videos from the user's library of electronic media. In certain embodiments, the device protective case includes a display, a power source, a microcontroller, memory, and a wireless antenna. The device protective case can be made out of any material capable of providing protection for the fragile and/or portable electronic device including but not limited to plastic, metal, rubber, polycarbonate (PC), thermoplastic polyurethane (TPU), thermoplastic, bioplastic, any biodegradable material, any compostable material, any recyclable material, any leather material, or any combination thereof. The microcontroller executes software that allows the case to communicate through the wireless antenna with a portable electronic device or similar device. The portable electronic device or similar device can store one or more media libraries. These media libraries can store still images in any format such as Photoshop Document (PSD), Portable Document Format (PDF), raw image formats, Tagged Image File (TIFF), Joint Photographic Experts Group (JPEG), Graphics Interchange Format (GIF), Portable Network Graphics (PNG), etc., and videos in any format such as MPEG-4 Part 14 (MP4), Quicktime File Format (MOV), Audio Video Interleave (AVI). Advanced Video Coding High Definition (AVCHD), Windows media video (WMV), Matroska (MKV), WebM, and other video formats. The electronic device paired to the device protective case can execute a program or application that allows a user to select one or more files from the media libraries to display on the device protective case and otherwise control it. For example, the program can then further allow the user to change media being displayed by the device protective case, vary its playback, and turn the display (or displays) on or off.

The technologies described herein provide a variety of benefits and advantages including the ability to provide a more visually interesting and stimulating protective case for portable electronic devices. The device protective case also makes use of area on the case for displaying images and video that has previously not been used. The device protective case also allows users to enjoy their images and videos stored on their electronic devices in a new way.

The technologies discussed herein can be used in a variety of different contexts and environments. One useful application of these technologies is in the context of a case for a cellular phone or smartphone. For example, the device protective case disclosed herein may be configured to attach to and protect a cellular phone or smart phone. The device protective case can be designed to attach securely to the cellular phone or smart phone and provide protection from scratching, cracking, and denting. The portable electronic device protective case can also provide additional protection to the internal electronic components of the portable electronic device. Device protective cases disclosed herein can be designed to protect tablet devices, laptop computers, digital music players, cameras, sensitive laboratory equipment, scientific tools, analytical instrumentation, heavy-duty communications systems including but not limited to internet service provider hardware, telephone system and networking equipment, intranet and extranet equipment, television broadcast equipment, cable equipment, satellite communications systems and equipment, surveillance or signal analysis systems or measuring devices, security systems, direction finding and jamming and/or any other military or security equipment, and other portable and/or fragile electronic devices. In certain embodiments, the device protective cases can be designed to protect non-electronic devices including, but not limited to, jewelry cases, keychain cases, and luggage (such as suitcases, briefcases, trunks, etc.).

The embodiments described in this disclosure can be combined in various ways. Any aspect or feature that is described for one embodiment can be incorporated to any other embodiment mentioned in this disclosure. Moreover, any of the embodiments described herein may be hardware-based, may be software-based, or, preferably, may comprise a mixture of both hardware and software elements. Thus, while the description herein may describe certain embodiments, features, or components as being implemented in software or hardware, it should be recognized that any embodiment, feature and/or component referenced in this disclosure can be implemented in hardware and/or software.

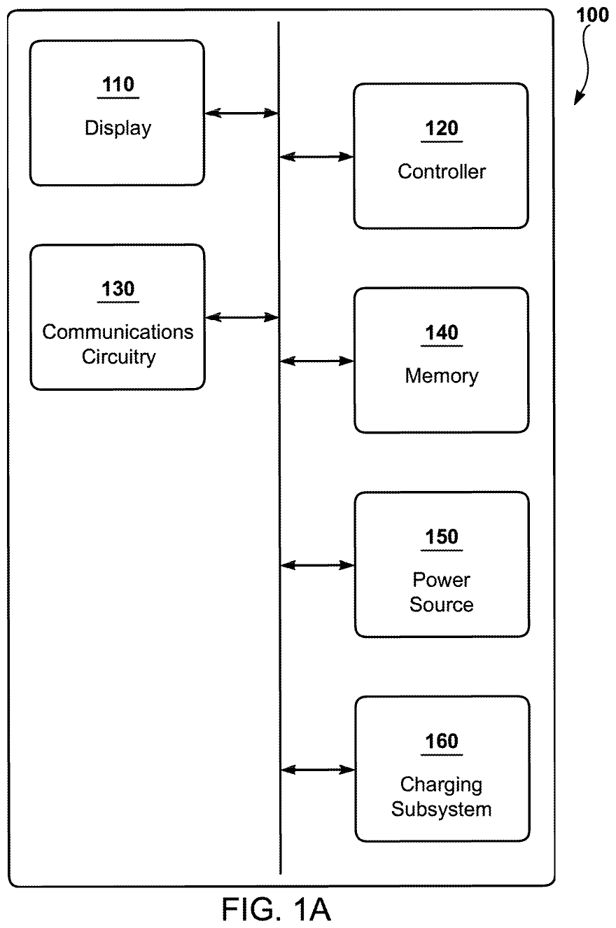

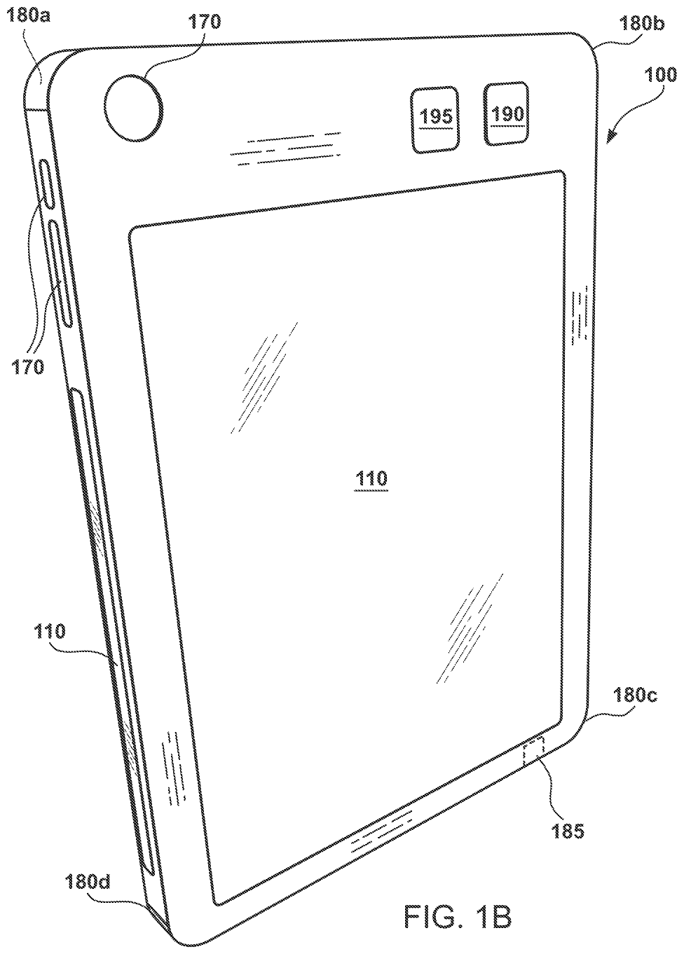

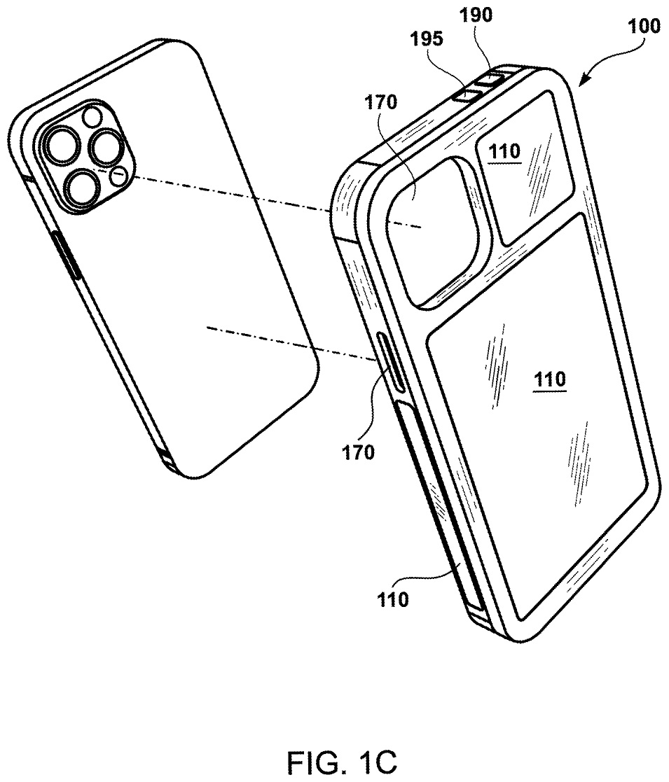

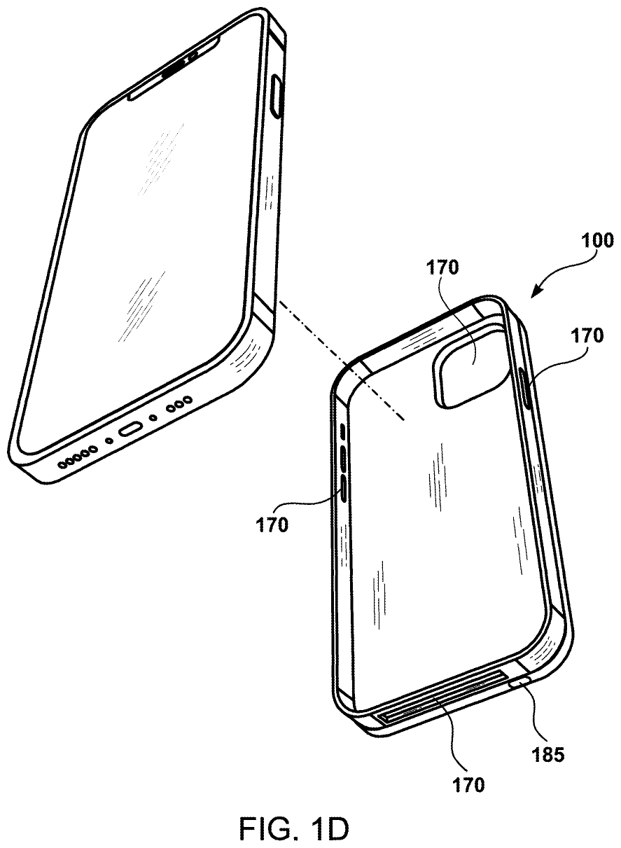

FIG. 1A is a block diagram of an exemplary system for a device protective case 100 in accordance with certain embodiments. FIGS. 1B, 1C, and 1D are diagrams illustrating additional features, components, and/or functions associated with the device protective case. FIGS. 1A, 1B, 1C, and 1D are jointly discussed below.

The device protective case 100 comprises one or more displays 110, one or more controllers 120, communications circuitry 130, one or more memories 140, one or more power sources 150, and at least one charging subsystem 160. In FIG. 1A, the subcomponents of the device protective case 100 are connected to each other and connected to the power source 150 to receive power through a bus configuration. Alternatively, or in addition, the various subcomponents can be connected to each other directly (that is, without being connected to each other through a central bus) or connected directly to the power source 150.

The display 110 can be any display capable of showing still images or video. In certain embodiments, the display 110 can be a liquid crystal display (LCD). The display 110 can also be a display comprising light emitting diodes (LEDs) without a backlight, such as an organic light emitting diode (OLED) display. In certain embodiments, the device protective case 100 may include one or more displays 110 and/or the display 110 (or each display 110) may include two or more display devices.

The device protective case 100 also includes one or more controllers 120. The controller 120 communicates with the other components of the device protective case 100, including the display 110, the communications circuitry 130, and the power source 150. In certain embodiments, the controller 120 also communicates with the charging subsystem 160 to monitor and regulate the charging of the power source 150. The controller 120 controls the functioning of the display 110 and the other components of the device protective case 100. The controller 120 can execute software code stored in the memory 140 to control the display 110 and play video or present still images on the display 110. The controller 120 communicates with and controls the communications circuitry 130. The controller 120 can receive commands from a portable electronic device (or another device connected or paired to it) to execute. These commands can include commands to change the image on the display 110 (or on one of the displays 110), to play a video on the display 110 (or on one of the displays 110), to store images and/or videos in the memory 140, and to delete an image or video from the memory 140.

The controller 120 can include an image processing unit to process the images and/or video displayed by the display 110. The controller 120 can also include a data processing unit for processing commands received by the device protective case 100, sending data to the portable electronic device (or another device to which it is paired, as discussed below), processing media received by the device protective case 100, storing and retrieving media from the memory 140, and sending and receiving data and commands from the communications circuitry 130. In certain embodiments, the image processing unit, the data processing unit, or both can be separate from the controller 120.

The controller 120 can comprise one or more central processing units (CPUs), one or more microprocessors, one or more microcontrollers, one or more controllers, one or more complex instruction set computing (CISC) microprocessors, one or more reduced instruction set computing (RISC) microprocessors, one or more very long instruction word (VLIW) microprocessors, one or more graphics processor units (GPU), one or more digital signal processors, one or more application specific integrated circuits (ASICs), and/or any other type of processor or processing circuit capable of performing desired functions. The one or more controllers 120 can be configured to execute any computer program instructions that are stored or included on computer storage devices (including the memory 140) including, but not limited to, instructions associated with displaying media on the display 110, sending and receiving commands and data through the communications circuitry 130, and storing and retrieving data and commands from the memory 140.

The communications circuitry 130 exchanges commands and data (such as media for display on the display 110) with other devices, including, for example, the portable electronic device protected by the device protective case. The communications circuitry 130 can use either wireless or wired protocols (or both) to exchange commands and data with other devices. For example, the communications circuitry 130 can exchange data and commands using WiFi, Bluetooth, infra-red, near field communications (NFC), cellular networks, the Internet, radio networks, television networks, and/or other types of wireless networks and protocols. In addition, or alternatively, the communications circuitry 130 can exchange data and commands via a wired connection using universal serial bus (USB 1.x, 2.x, 3.x, 4.x, USB-C, etc.), Small Computer System Interface (SCSI), AT Attachment (ATA), Serial ATA (SATA), Ethernet, and/or other types of wired networks and protocols.

The communications circuitry 130 can send and receive data and commands from and to the device to which it is paired, including for instance a portable electronic device. For example, the portable electronic device can send media including video, still images, or both to the device protective case 100 that are received by the communications circuitry 130. The communications circuitry 130 can also receive commands, such as to change the video or image on the display 110, delete a certain file from the memory 140, to power down the device protective case 100, to power on the device protective case 100, etc., from the portable electronic device. The communications circuitry 130 can receive instructions from the controller 120 to transmit data to the portable electronic device such as the status of the power source 150, amount of storage free or used in the memory 140, a list of the files stored in the media 140, etc.

In certain embodiments, the communications circuitry 130 can communicate with other devices than the device to which the device protective case 100 is attached. For example, the device protective case 100 can receive media files from a cloud computing service, a network server, a website, an external hard drive or other external storage device, a computer, a smartphone, a tablet, a camera, or other electronic device capable of storing and transmitting media files such as images and/or video. The portable electronic device case 100 can also receive commands from and/or send data to computers, servers, smartphones, tablets, a camera, or other electronic devices capable can of sending and receiving data and commands. For example, the device protective case 100 can receive commands (such as to change the image shown on the display 110, etc.) from and send data (such as the amount of battery life left in the power source 150, the amount of space left in the memory 140, etc.) to a user's smartphone or computer when the device protective case 100 is protecting another device. In certain embodiments, the device protective case 100 can receive commands from a server via the communications circuitry 130. The server can be connected to the user's device via a network, such as the Internet or a similar such network, and act as a relay between the device protective case 100 and the user's device, sending commands to the device protective case 100 (such as to change the image shown on the display 110, etc.) and receiving data from the device protective case 100 (such as the amount of battery life left in the power source 150, the amount of space left in the memory 140, etc.).

The memory 140 can store media, other data, and software code. The memory 140 can store files such as image and video files. The memory 140 can also store software code that is executed by the controller 120. The memory 140 can receive commands from the controller 120 to retrieve media files (such as still images and/or video) for display by the display 110. The memory 140 can also store media and other files received by the communications circuitry 130.

The memory 140 can include (i) non-volatile memory, such as, for example, read only memory (ROM) (that can, for example, store executable code for the controller 120 to execute) and/or (ii) volatile memory, such as, for example, random access memory (RAM). The non-volatile memory may be removable and/or non-removable non-volatile memory. Meanwhile, RAM may include dynamic RAM (DRAM), static RAM (SRAM), etc. Further, ROM may include mask-programmed ROM, programmable ROM (PROM), one-time programmable ROM (OTP), erasable programmable read-only memory (EPROM), electrically erasable programmable ROM (EEPROM) (e.g., electrically alterable ROM (EAROM) and/or flash memory), etc. In certain embodiments, the memory 140 can be any physical, non-transitory medium. The memory 140 can store instructions associated with the display of video and still images on the display(s) 110 and the reception of data and commands from the communications circuitry 130 and the sending of data through the communications circuitry 130.

The device protective case 100 includes one or more power sources 150. The power source(s) 150 can include any type of alternating current (AC) power source and/or direct current (DC) power source. In certain embodiments, the one or more power sources 150 can include one or more batteries (e.g., one or more removable or non-removable, rechargeable and/or non-rechargeable batteries). The one or more power sources 150 can be utilized to supply power to the other components of the device protective case 100.

The device protective case 100 can also include charging subsystem 160 to recharge the power source 150. The charging subsystem 160 can utilize either wireless or wired recharging methods. The charging subsystem 160 can be recharged by a wireless charging accessory or a wired charging accessory or wireless charging from the portable electronic device itself. Alternatively, or in addition, the power source 150 can include one or more replaceable batteries that can be replaced once one or more of batteries lose a certain amount of charge.

In certain embodiments, the controller 120 receiving one or more additional videos or images through the communications circuitry 130; store the one or more additional videos or images in the memory 140; end the display of the first video or image (or the preceding video or image) on the display 110; and display the one or more videos or images on the display 110. The one or more videos or images can comprise videos or images or a mix of videos and images to be played in a predefined sequence. In certain embodiments where the device protective case 100 has more than one display 110, the controller 120 can display at least some of the videos or images in the predefined sequence on a second display 110 of the device protective case 100. The control 120 can receive a command through the communications circuitry 130 to cease displaying videos or images on the display 110 (or one of the displays 110). In certain embodiments, the controller 120 can end the display of the video or image on the display 110 (or one of the displays 110) based on a calculation performed by the controller 120. For example, this calculation can be based on reaching a certain time limit, based on the amount of time since the device protective case received a command or request through the communications circuitry 130, or based on some other factor, such as battery life.

FIG. 1B is a diagram of the exterior of an exemplary apparatus for a device protective case 100 in accordance with certain embodiments. The device protective case 100 can include one or more displays 110, one or more cutouts 170, one or more attachment mechanisms 180a-d, one or more connectors 185, one or more buttons 190 (such as a power button), and/or one or more indicators 195. In embodiments where the device protective case 100 is multisided, one or more of the display(s) 110, cutout(s) 170, attachment mechanism(s) 180a-d, one or more connectors 185, button(s) 190, and/or one or more indicators 195 can appear on any side of the device protective case 100. The exterior and the shape of the device protective case 100, more generally, can be designed to fit a particular type of device. In certain embodiments, the device protective case 100 can be comprised of two or more pieces, for instance to better attach to the device it is protecting (discussed in more detail below). For example, the shape of the device protective case 100 can be designed to fit a particular brand or model of smartphone, tablet, laptop computer, a camera, etc. In addition, or alternatively, the device protective case 100 can be designed to fit a broad range of brands and/or models of smartphone, table, laptop computer, piece of electronic equipment, devices, etc.

As discussed above, the device protective case 100 includes one or more displays 110. The one or more displays 110 can be situated anywhere on the exterior of the device protective case 100. The displays 110 can be flat (that is, existing in a single plane) or curved. In certain embodiments, one or more edges of the one or more displays 110 extend up to the edge of the device protective case 100. The displays 110 can take any shape, including that of a rectangle, square, circle, oval, or triangle. In embodiments with more than one display 110, the displays 110 can be placed next to each other on the exterior of the device protective case 100 or they may be separated from each other or on different sides of the device protective case 100.

The device protective case 100 can also include one or more cutouts 170. The cutouts 170 are portions of the device protective case 100 where the device protective case 100 is not covering the device it protects. The cutouts 170 can take any shape, including that of a rectangle, square, circle, oval, or triangle. The cutouts 170 can be any size. In certain embodiments, the cutouts 170 can be sized, shaped, and placed in such a way on the device protective case 100 so as to not obscure an external feature of the portable electronic device, such as a button or keyboard (or other mechanism for receiving input from the user), camera, camera flash, screen, indicator, connector, or other feature that cannot be covered and remain functional. In certain embodiments, the cutouts 170 can be designed in such a way that the cutout can be ‘opened’ or ‘closed’ (such as by providing a flap attached to the device protective case 100 that fits over the cutout 170) so that the external feature of the protected device can be protected when it is not in use. In certain embodiments, one or more edges of the one or more cutouts 170 extend up to the edge of the device protective case 100. In certain embodiments, the cutouts 170 can also be covered with a flexible material, such as rubber, to provide protection to an external feature (such as a button or switch) while also allowing the user to access and/or manipulate the feature.

The device protective case 100 can also include attachment mechanisms 180a-d. Attachment mechanisms 180a-d can be placed anywhere on the device protective case 100 and can be any kind of mechanism that can affix the device protective case 100 to the device it is protecting including hooks, straps, brackets, notches, etc. The device protective case 100 can use any combination of mechanism to affix itself to the device. The attachment mechanisms 180a-d can also be detachable from the main body of the device protective case 100. In certain embodiments, the attachment mechanisms 180a-d can be designed as male-female pairs to help secure the device protective case 100 to the device that it is protecting. For instance, the device protective case 100 can be divided into two or more pieces which are designed to attach to each other using the male-female pairs to help secure the pieces of the device protective case 100 to each other and to attach the device protective case 100 to the device it is protecting. Alternatively, or in addition, the device protective case 100 can be designed to fit the protected device in such a way as to not require a discrete attachment mechanism 180 (or to provide further security). For example, the device protective case 100 can be designed to slip on the device that it is protecting (and with the rigidity of the device protective case 100 being either soft or hard) or it may snap on to or grip the device (with the rigidity of the device protective case 100 being either soft or hard). In certain embodiments, the device protective case 100 can include magnets to affix itself to the device either in addition to discrete attachment mechanisms 180a-d or the form fit of the device protective case 100 to the protected device, or alternatively to these other techniques of affixing the device protective case 100 to the protected device.

The device protective case 100 can also include one or more connectors 185. The connectors 185 can be situated anywhere on the device protective case 100, including near its edges, and can take any shape necessary to facilitate a connection between the device protective case 100 and an external device or an electrical outlet. In certain embodiments, the connector 185 can conform to the standard for a socket for a wired communications protocol, such as High Definition Multimedia Interface (HDMI), Thunderbolt, other video communications connection protocols, universal serial bus (USB 1.x, 2.x, 3.x, 4.x, USB-C, etc.), Small Computer System Interface (SCSI), AT Attachment (ATA), Serial ATA (SATA), and Ethernet. Alternatively, or in addition, the device protective case 100 can include a connector 185 for any type of standard power plug capable of recharging a device power source. In certain embodiments, the one or more connectors 185 can be adapted for more than one function and/or more than one standard. For example, a connector 185 can be adapted to facilitate wired communication and to act as a power connection. In embodiments where the device protective case 100 can communicate via a wired connection, one or more connectors 185 are coupled to the communication circuitry 130. In embodiments where the portable electronic device 100 can recharge the power source 150 via a wired connection, one or more connectors 185 are coupled to the charging subsystem 160.

The device protective case 100 can also include one or more buttons 190 and/or indicators 195. The buttons 190 and the indicators 195 can be any shape and size and be positioned anywhere on the device protective case 100. The buttons 190 can be any kind of button, tab, switch, knob, or other mechanism for accepting input from a user. The button can control any function of the device protective case 100 and/or the device. For example, the device protective case 100 can have a button (or buttons) 190 for turning the device protective case 100 on or off, resetting the device, controlling aspects of the display(s) 110 (such as its/their brightness(es), contrast(s), etc.), controlling the volume of the protected device, etc. The indicators 195 can be any kind of visual indicator including lights (including solid, beeping, and/or flashing) of any color or intensity, symbols (such as a battery with a certain percentage of the interior filled that corresponds to the percentage of battery life left), and bars (such as to represent signal strength or volume, etc.). In certain embodiments, an indicator 195 can be superimposed over a button 190 (such as an cony light being placed on an con/off′ button). In certain embodiments, one or more displays 110 can also be a touchscreen capable of accepting input from a user.

FIG. 1C is a diagram of the exterior of an exemplary apparatus for a device protective case 100 in relation to a portable electronic device in accordance with certain embodiments. The device protective case 100 can include one or more displays 110, one or more cutouts 170, one or more attachment mechanisms 180a-d (not shown on this figure), one or more connectors 185 (not shown here), one or more buttons 190 (such as a power button), and/or one or more indicators 195. The cutouts 170 provide spaces in the device protective case 100 to prevent it from obscuring certain sensors (such as for example, a camera lens or lenses, camera flash, etc.), indicators (such as, for example, indicator lights) and/or inputs (such as, buttons, switches, tabs, etc.). The displays 110 can be positioned on any side of the device protective case 100. In certain embodiments, the displays 110 can be recessed in the external face of the device protective case 100 (that is where display is slightly below, and not flush with, the rest of the external face of the device protective case 100) to provide the displays 110 with additional protection. The one or more buttons 190, indicators 195, and connectors 185 (not shown here) can be situated on any portion of any side of the device protective case 100. In certain embodiments, the one or more buttons 190, indicators 195, and connectors 185 (not shown here) are situated so that they are easily accessible to the user when the device protective case 100 is affixed to a device.

FIG. 1D is a diagram of the exterior of an exemplary apparatus for a device protective case 100 in relation to a portable electronic device in accordance with certain embodiments. The device protective case 100 can include one or more displays 110 (not shown), one or more cutouts 170, one or more attachment mechanisms 180a-d (not shown on this figure), one or more connectors 185, one or more buttons 190 (not shown), and/or one or more indicators 195 (not shown). In certain embodiments, the device protective case 100 can be designed so that a certain type or model of portable electronic device can securely fit (or ‘snap’ into the device protective case 100 by having the sides of the device protective case 100 grip the portable electronic device) in the device protective case 100 without the requiring separate attachment mechanisms 180a-d.

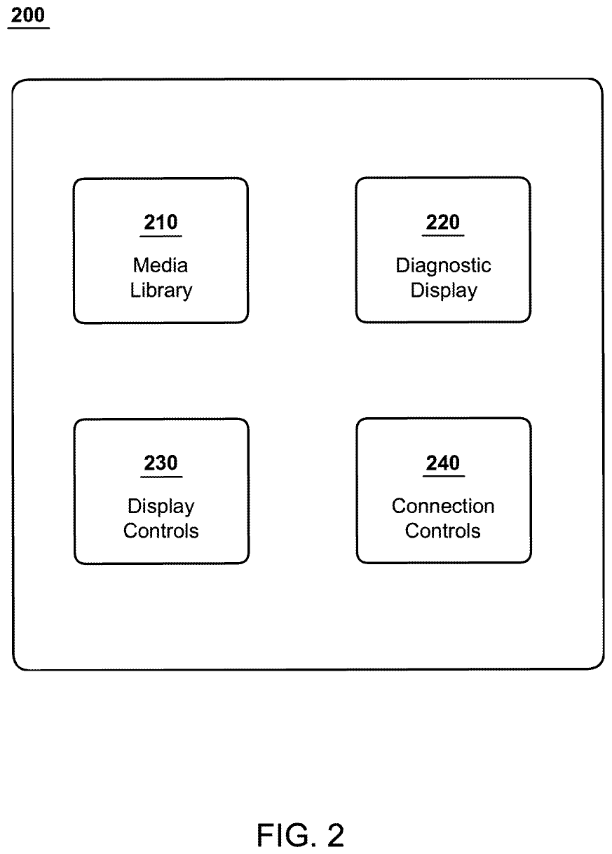

FIG. 2 is a block diagram showing the functional features of a device cover application 200 that communicates with and helps control the device protective case 100 (and its display(s) 110). The device cover application 200 is able to access one or more media libraries 210 containing still images and/or videos. The media libraries 210 can be stored on the same device as the device cover application 200 and/or on an external storage device (such as a flash drive or external hard drive) wirelessly connected or through a wired connection to either the device running the device cover application 200 or the device protective case 100. In addition, or alternatively, one or more media libraries 210 may be stored on a server or on a cloud-based platform and accessible through a network, such as cellular phone network and/or the Internet.

The device cover application 200 can also include a diagnostic display 220. The diagnostic display 220 can display through the device cover application 200 the status of the device protective case 200 to which the device cover application 200 is connected (or ‘paired’). The status information can include any type of information regarding the functioning of the device protective case 100 including battery charge, battery life left, signal status, power charging status, software update and/or diagnostic status, etc.

The device cover application 200 also includes display controls 230. The display controls 230 provides the user with a means to control and/or adjust the images and/or videos being displayed on the portable electronic device cover 100. The display controls 230 can list the media libraries 210 and/or media files that can be accessed for display on the device protective case 100. The display controls 230 can also provide tools for controlling the display(s) 110 on the device protective case 100. For example, the display controls 230 can allow the user to select or change the image currently being displayed on the device protective case 100 and/or to create a playlist of still images and/or videos for display on the device protective case 100. The display controls 230 can also allow users to select the timing each still image will be displayed and/or to control the playback speed of videos on the device protective case 100. Other display control options can include rewinding, fast forwarding, or skipping through playlists or videos, pausing playlists or videos, and adjusting the transitions from one image/video to another (for example by having one image/last frame(s) of the video fade out before the next video/image appears, etc.). The display controls 230 can also allow users to select certain playback modes (such as a screensaver mode or the time limit or other conditions before screensaver mode begins) for the display(s) 110 on the device protective case 100. In embodiments where the device protective case 100 includes more than one display 110, the display controls 230 can control each display 110 separately or as one unified display.

The display controls 230 can be used to add or delete media files from memory 140 of the device protective case 100. Such deletion or addition of media files can be done automatically by the device cover application 200 (for example, when the user wishes to play a playlist of media files not currently stored in the memory 140 and/or to free up space in the memory 140 by deleting media files no longer scheduled to display or which have not been displayed in a certain period of time). The display controls 230 can also provide tools to a user to manually delete media files stored in the memory 140 or to manually transfer media files to the device protective case 100.

The display controls 230 can also allow the user to adjust certain settings of the device protective case 100. For example, the display controls 230 can control the contrast, resolution, brightness, and other settings of the one or more displays 110 either automatically (for example, to preserve battery life or to maximize the image or video sharpness on one of the displays 110) or manually based on input received from the user. The display controls 230 can also be used to turn off, wake up, put to sleep, or turn on the device protective case 100 (and/or a selected display 110).

The device cover application 200 can also include connection controls 240. Connection controls 240 can control the pairing process of connecting the device cover application 200 to a device protective case 100. The pairing process can be accomplished in any way capable of pairing two devices over a wireless or wired connection. In embodiments where a device cover application 200 is coupled or paired to more than one device protective case 100, the connection controls 240 can be used to select the device protective case to control via the display controls 230 or receive diagnostic information via the diagnostic display 220.

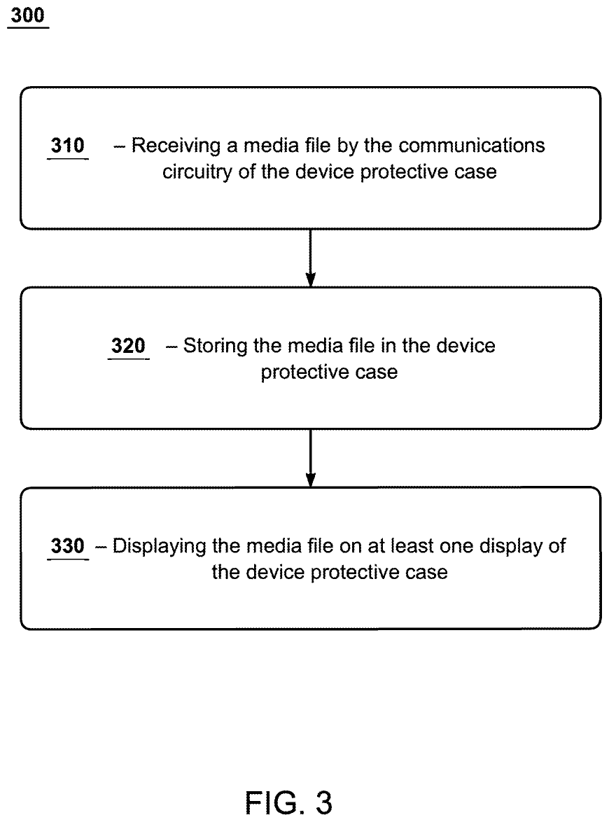

FIG. 3 illustrates a flow chart for an exemplary method 300, according to certain embodiments. Method 300 is merely exemplary and is not limited to the embodiments presented herein. Method 300 can be employed in many different embodiments or examples not specifically depicted or described herein. In some embodiments, the steps of method 300 can be performed in the order presented. In other embodiments, the activities of method 300 can be performed in any suitable order. In still other embodiments, one or more of the steps of method 300 can be combined or skipped. In many embodiments, device protective case 100 and/or device cover application 200 can be configured to perform method 300 and/or one or more of the steps of method 300. In these or other embodiments, one or more of the steps of method 300 can be implemented as one or more computer instructions configured to run at one or more processing devices (such as the controller 120 and/or the processor(s) of the device on which the device cover application 200 is executed) and configured to be stored at one or more non-transitory computer storage devices (such as the memory 140 and/or the computer storage devices of or accessible by the device on which the device cover application 200 is executed).

Step 310 includes receiving a media file by the communications circuitry 130 of the device protective case 100. The media file can be sent to the device protective case 100 from a cloud computing platform, a service, an external storage device such as a flash drive or external hard drive, or another electronic device such as a computer or portable electronic device.

Step 320 includes storing the media file in the device protective case 100 before it is displayed by the device protective case 100.

Step 330 includes displaying the media file on at least one display 110 of the device protective case 100. In embodiments where there are more than one display 110, the media file (that is still image or video) can be displayed on only one display 110, mirrored on each display 110, or distributed across the displays 110. In embodiments where the device protective case 100 has more than one display 110 and receives or has received more than one image and/or video, the device protective case 100 can display separate images or videos on each of the displays 110 simultaneously.

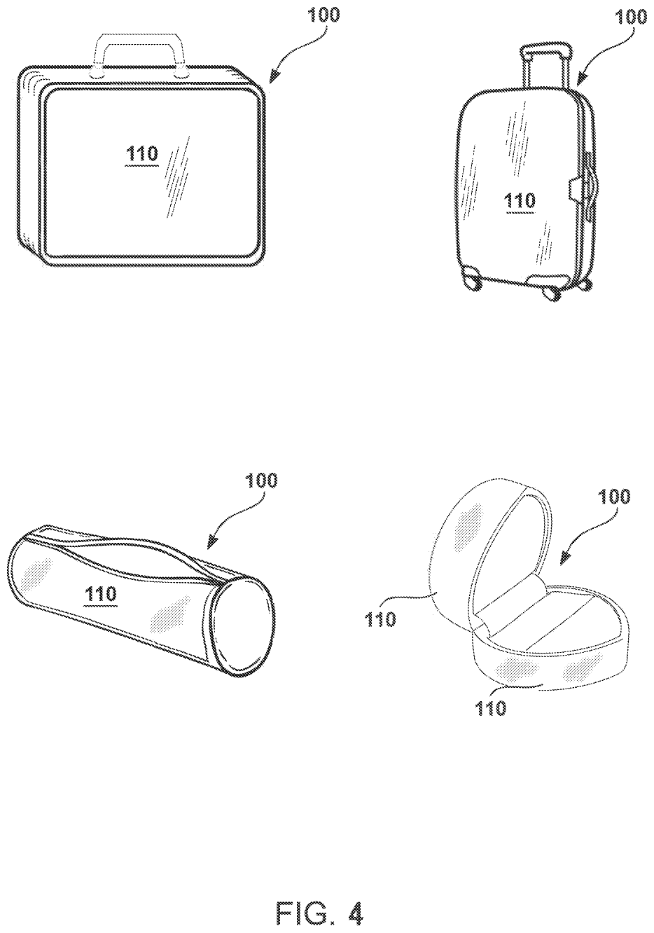

FIG. 4 is an illustration demonstrating exemplary features of the device protective case 100 in accordance with certain case structures. In embodiments where the device protective case 100 is/isn't multisided can include one or more of the display(s) 110, cutout(s) 170 (not shown), attachment mechanism(s) 180a-d (not shown), one or more connectors 185 (not shown), button(s) 190 (not shown), and/or one or more indicators 195 (not shown) can appear on any side of the device protective case 100. The exterior and the shape of the device protective case 100, more generally, can be designed to fit a particular type of object or many objects. As for illustration purposes FIG. 4 is merely an exemplary example of showing all the cases that the display could be located on the protective case. The device protective case 100 can be a jewelry case protecting jewelry, a luggage case protecting objects within it, a suitcase protecting the objects inside it, a sports bag or pencil case protecting the objects inside or within it, while having one or more displays 110, etc.

In certain embodiments, an apparatus for protecting a device comprises a protective casing further comprising: at least one display; at least one controller; memory; communications circuitry; and a power source; wherein the at least one display displays an image or video stored in the memory of the apparatus; and the image or video was received through the communications circuitry.

In certain embodiments, a method is implemented via execution of computing instructions configured to run at one or more controllers and configured to be stored on non-transitory computer-readable memory of an apparatus for protecting another device further comprising communications circuitry and a display, the method comprising: receiving a video or image through the communications circuitry; storing the video or image received by the communications circuitry in the memory; and displaying the at least one video or image stored in the memory on the display.

In certain embodiments, a computer program product, the computer program product comprising a non-transitory computer-readable medium includes instructions for causing a computing device in an apparatus for protecting another device to: receiving a video or image through communications circuitry in the apparatus; storing the video or image received by the communications circuitry in memory of the apparatus; and displaying the at least one video or image stored in the memory on a display of the apparatus.

While various novel features of the invention have been shown, described, and pointed out as applied to particular embodiments thereof, it should be understood that various omissions and substitutions, and changes in the form and details of the systems and methods described and illustrated, may be made by those skilled in the art without departing from the spirit of the invention. Amongst other things, the steps in the methods may be carried out in different orders in many cases where such may be appropriate. Those skilled in the art will recognize, based on the above disclosure and an understanding of the teachings of the invention, that the particular hardware and devices that are part of the system described herein, and the general functionality provided by and incorporated therein, may vary in different embodiments of the invention. Accordingly, the description of system components are for illustrative purposes to facilitate a full and complete understanding and appreciation of the various aspects and functionality of particular embodiments of the invention as realized in system and method embodiments thereof. Those skilled in the art will appreciate that the invention can be practiced in other than the described embodiments, which are presented for purposes of illustration and not limitation. Variations, modifications, and other implementations of what is described herein may occur to those of ordinary skill in the art without departing from the spirit and scope of the present invention and its claims.

1. An apparatus for protecting a device or object comprising:
a protective casing further comprising:
at least one display;
at least one controller;
memory;
communications circuitry; and
a power source;
wherein the at least one display displays an image or video stored in the memory of the apparatus; and
the image or video was received through the communications circuitry.

2. The apparatus of claim 1 wherein the apparatus further comprises a charging subsystem for recharging the power source of the apparatus.

3. The apparatus of claim 2 wherein the power source of the apparatus is recharged through the charging subsystem wirelessly, non-wirelessly, or with a combination of the two.

4. The apparatus of claim 1 wherein the apparatus receives at least one command or request from an external device through the communications circuitry to be executed by the at least one controller.

5. The apparatus of claim 4 wherein the request received is a request for the amount of storage space left in the memory.

6. The apparatus of claim 4 wherein the command received is a command to change the image or video currently displayed on the at least one display.

7. The apparatus of claim 4 wherein the command received by the communications circuitry and executed by the at least one controller is a command to display a playlist of images or videos or both on the display.

8. The apparatus of claim 1 wherein the protective casing is made out of one of the following: plastic, metal, rubber, a polycarbonate material, a biodegradable material, a recyclable material, a compostable material, or leather.

9. The apparatus of claim 1 wherein the apparatus has two or more displays.

10. The apparatus of claim 9 wherein the two or more displays display different videos or images from one another.

11. The apparatus of claim 4 wherein the command received from the external device is a command to turn all displays of the apparatus off.

12. The apparatus of claim 4 wherein the command received from the external device is the command to turn at least one display on.

13. The apparatus of claim 1 wherein the protective casing further comprises an on/off control.

14. A method implemented via execution of computing instructions configured to run at one or more controllers and configured to be stored on non-transitory computer-readable memory of an apparatus for protecting another device further comprising communications circuitry and a display, the method comprising:
receiving a video or image through the communications circuitry;
storing the video or image received by the communications circuitry in the memory; and
displaying the at least one video or image stored in the memory on the display.

15. The method of claim 14 further comprising:
receiving one or more additional videos or images through the communications circuitry;
storing the one or more additional videos or images in the memory;
ending the display of the first video or image on the display; and
displaying the one or more videos or images on the display.

16. The method of claim 15 wherein the one or more videos or images comprise videos or images or a mix of videos and images to be played in a predefined sequence.

17. The method of claim 16 further comprising:
displaying at least some of the videos or images in the predefined sequence on a second display of the apparatus.

18. The method of claim 16 further comprising:
receiving a command through the communications circuitry to cease displaying videos or images on the display.

19. The method of claim 14 further comprising:
ending the display of the one video or image on the display based on a calculation performed by one or more controllers in the apparatus.

20. A computer program product, the computer program product comprising a non-transitory computer-readable medium including instructions for causing a computing device in an apparatus for protecting another device to:
receiving a video or image through communications circuitry in the apparatus;
storing the video or image received by the communications circuitry in memory of the apparatus; and
displaying the at least one video or image stored in the memory on a display of the apparatus.
